(19) United States
(12) Patent Application Publication
(10) Pub. No.: US 2014/0128164 A1
(43) Pub. Date: May 8, 2014

(54) SERVER DEVICE, AND NON-TRANSITORY COMPUTER-READABLE STORAGE MEDIUM STORING GAME PROGRAM

(71) Applicant: DeNA Co., Ltd., Tokyo (JP)

(72) Inventors: Yuji UKAI, Tokyo (JP); Takahiro EZAKI, Tokyo (JP); Tomoyuki ONO, Tokyo (JP)

(73) Assignee: DeNA Co., Ltd., Tokyo (JP)

(21) Appl. No.: 14/045,123

(22) Filed: Oct. 3, 2013

(30) Foreign Application Priority Data
Nov. 6, 2012 (JP) 2012-244761

(51) Int. Cl. A63F 13/12

(52) U.S. Cl. CPC A63F 13/12
USPC 463/42

(57) ABSTRACT

A server device connected with a player terminal in a manner capable of information communication includes: a storage unit configured to store deck information in which a plurality of game contents held in a deck is set, and group information in which a plurality of groups configured from game contents that serve as selection candidates among the plurality of game contents held in the deck; a providing unit configured to sequentially select the groups according to a selection order set in advance based on the group information, and to provide the player with a game content selected from the game contents that serve as the selection candidates for each sequentially selected group, in response to a request from the player terminal; and an update unit configured to update the deck information so that the game content provided by the providing unit becomes a game content not held in the deck.

### CROSS-REFERENCE TO RELATED APPLICATION(S)

This application claims the benefit of Japanese Patent Application No. 2012-244761, filed Nov. 6, 2012, the disclosure of which is hereby incorporated by reference in its entirety.

### BACKGROUND OF THE INVENTION

1. Field of the Invention

The present invention relates to a server device and a program.

2. Description of Related Art

A game system in which a player executes a game using game contents such as character cards has been known (for example, Japanese Patent Application Laid-Open No. 2008-264183).

### SUMMARY OF THE INVENTION

In this game system, the game contents to be used in the game is provided to the player. At this time, the player needs to perform an operation input for consuming a game value such as points possessed by the player.

Here, when there are many methods to provide the player with the game contents, the player needs to perform the operation input according to each of the methods. Further, in this case, it may be difficult for the player to understand the most efficient order to operate.

The present invention has been made in view of the foregoing, and an objective is to reduce work required for an operation input.

A principal invention of the present invention to solve the above-described problems is

a server device connected with a player terminal used by a player in a manner capable of information communication, and the server device includes:

a storage unit configured to store deck information in which a plurality of game contents held in a deck is set, and group information in which a plurality of groups configured from game contents that serve as selection candidates among the plurality of game contents held in the deck;

a providing unit configured to sequentially select the groups according to a selection order set in advance based on the group information, and to provide the player with a game content selected from the game contents that serve as the selection candidates for each sequentially selected group, in response to a request from the player terminal; and

an update unit configured to update the deck information so that the game content provided by the providing unit becomes a game content not held in the deck.

Other characteristics of the present invention will become clear from the description of the present specification and the appended drawings.

According to the present invention, work required for an operation input can be reduced.

### BRIEF DESCRIPTION OF THE DRAWINGS

FIG. 1 is a diagram illustrating an overall configuration example of a game system;

FIG. 2 is a block diagram illustrating a functional configuration of a server device;

FIG. 3 is a block diagram illustrating a functional configuration of a player terminal;

FIG. 4 is a diagram illustrating an example of a data structure of card information;

FIG. 5 is a diagram illustrating an example of a data structure of player information;

FIG. 6 is a diagram illustrating an example of a data structure of possessed medal information;

FIG. 7 is a diagram illustrating an example of a data structure of possessed card information;

FIG. 8 is a diagram illustrating an example of a data structure of deck information;

FIG. 9 is a diagram describing group information;

FIG. 10 is a flowchart for describing an operation example of a game system;

FIG. 11 is a diagram illustrating an example of a game screen for performing reservation registration;

FIG. 12 is a diagram illustrating an example of a game screen for inputting a game value; and

FIG. 13 is a flowchart for describing an automatic gasha process.

### DETAILED DESCRIPTION OF THE INVENTION

At least the following matters will become clear according to the description of the present specification and the appended drawings.

That is, a server device connected with a player terminal used by a player in a manner capable of information communication, and the server device includes:

a storage unit configured to store deck information in which a plurality of game contents held in a deck is set, and group information in which a plurality of groups configured from game contents that serve as selection candidates among the plurality of game contents held in the deck;

a providing unit configured to sequentially select the groups according to a selection order set in advance based on the group information, and to provide the player with a game content selected from the game contents that serve as the selection candidates for each sequentially selected group, in response to a request from the player terminal; and

an update unit configured to update the deck information so that the game content provided by the providing unit becomes a game content not held in the deck.

According to such a server device, suitable groups are automatically selected in sequence without an operation by the player, and a game content selected from each sequentially selected group is provided to the player. Therefore, the work required for the operation input can be reduced.

Further, in the server device,

in the deck information, the held number of game contents to be held in the deck may be set corresponding to each game content, and

the providing unit may select a next group based on the held number of game contents that serve as selection candidates configuring a selected current group.

According to such a server device, the groups can be selected in an advantageous order for the player.

Further, in the server device,

in the deck information, the degree of rarity classified into a plurality of classes according to a rarity value may be set corresponding to each game content, and

the providing unit first may select the group having a configuration including a game content corresponding to the degree of rarity of the lowest class.

According to such a server device, by the group being selected first, a possibility in which a game content having a higher degree of rarity is selected from selection candidates of a next selected group can be enhanced.

Further, in the server device, in the deck information,

the degree of rarity classified into a plurality of classes according to a rarity value may be set corresponding to each game content, and the group information is configured such that, among the plurality of groups, a class of the degree of rarity corresponding to any game content among game contents that serve as selection candidates and configure one group, and a class of the degree of rarity corresponding to any game content among game contents that serve as selection candidates and configure another group accord with each other, and

the providing unit, between the one group and the another group, may first select a group including a game content corresponding to the degree of rarity of a lower class than the classes in accord in the game contents that serve as the selection candidates.

According to such a server device, a game content corresponding to the degree of rarity of a lower class than the classes in accord can be decreased from the deck. Therefore, a possibility in which a game content corresponding to the degree of rarity is selected from selection candidates of a next selected group can be enhanced.

Further, the server device may include:

a registration unit configured to register the degree of rarity designated by the player in advance;

a determination unit configured to determine whether the provided game content is made to be the game content possessed by the player by comparing the degree of rarity of the game content provided by the providing unit and the designated degree of rarity;

a fusion processing unit configured to apply fusion to the provided game content and another game content to generate a single game content after fusion, when it is determined that the provided game content is not made to be the game content possessed by the player; and

a recording unit configured no to record the provided game content as the game content possessed by the player, and to record the game content after fusion as the game content possessed by the player.

According to such a server device, the provided game content is automatically subjected to fusion. Therefore, the work required for the operation input can be reduced.

Further, the server device may include:

a registration unit configured to register the degree of rarity designated by the player in advance;

a determination unit configured to determine whether the provided game content is made to be the game content possessed by the player by comparing the degree of rarity of the game content provided by the providing unit and the designated degree of rarity;

a game value providing unit configured to convert the provided game content into a game value corresponding to a value of the game content, and to provide the player with the converted game value, when it is determined that the provided game content is not made to be the game content possessed by the player.

According to such a server device, the provided game content is automatically converted into a game value. Therefore, the work required to the operation input can be reduced.

Further, in the server device,

the storage unit may store player information in which a game value possessed by the player is set for each type, and

the providing unit may cause each type of the game value possessed by the player to be consumed, and provides the game content to be held in the deck, and

in providing the game content, sequentially select any group from a plurality of groups based on each type of the consumed game value.

According to such a server device, the group is automatically selected based on types of game value. Therefore, the work required for the operation input can be reduced.

Further, in the server device,

the storage unit may store player information in which an amount of a game value possessed by the player is set, and

the providing unit may

cause the game value possessed by the player to be consumed, and provides the game content to be held in the deck, and

in providing the game content, select any group from a plurality of groups based on the amount of the consumed game value.

According to such a server device, the group is automatically selected based on the amount of game value. Therefore, the work required for the operation input can be reduced.

Further, the server device may include

an initialization processing unit configured to initialize the deck information updated by the update unit according to an initialization condition having been satisfied.

According to such a server device, the game content is supplied in the deck by the initialization of the deck information. Therefore, the player is motivated to acquire the game content.

Further, a non-transitory computer-readable storage medium storing game program for causing a computer as a server device connected with a player terminal used by a player in a manner capable of information communication to execute the processes of:

storing, in a storage unit, deck information in which a plurality of game contents held in a deck is set, and group information in which a plurality of groups configured from game contents that serve as selection candidates among the plurality of game contents held in the deck;

sequentially selecting the groups according to a selection order set in advance based on the group information, and providing the player with a game content selected from the game contents that serve as the selection candidates for each sequentially selected group, in response to a request from the player terminal; and

updating the deck information stored in the storage unit so that the provided game content becomes a game content not held in the deck.

According to such a server device, the work required for the operation input can be reduced.

### Embodiments

### <<Configuration of Game System 1>>

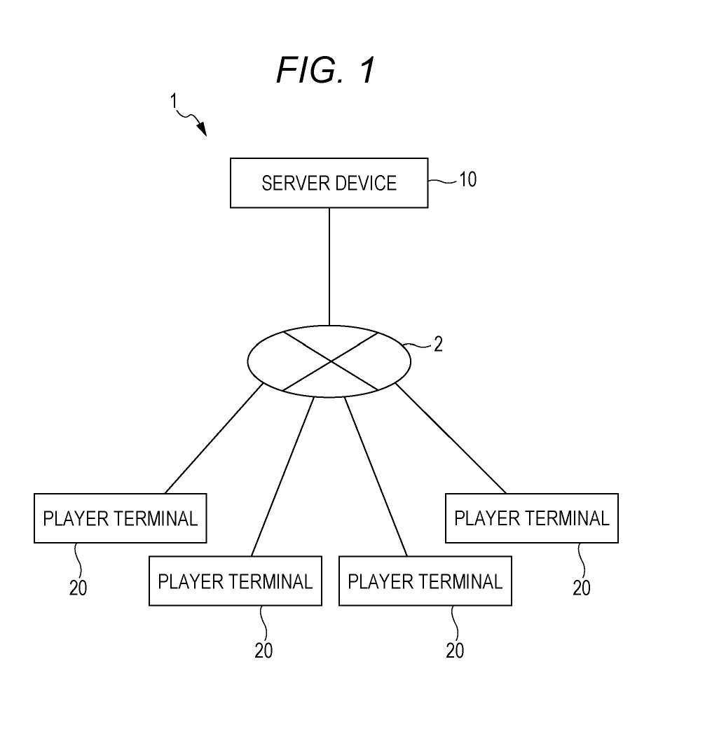

FIG. 1 is a diagram illustrating an example of an overall configuration of a game system 1 according to the present embodiment. The game system 1 provides a player with various services related to games through a network 2 (for example, the Internet and the like), and includes a server device 10 and a plurality of player terminals 20.

### <<Configuration of Server Device 10>>

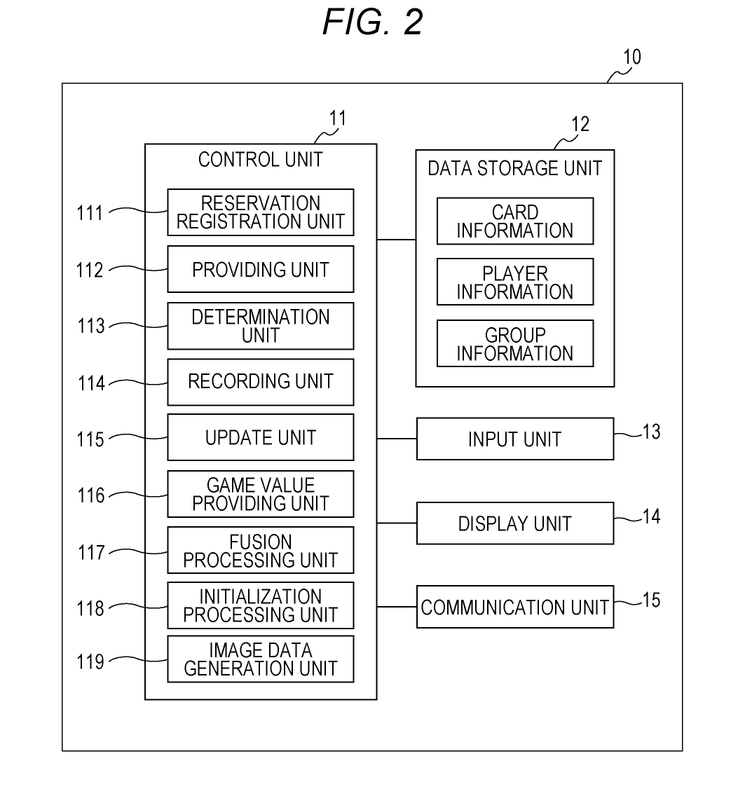

FIG. 2 is a block diagram illustrating a functional configuration of the server device 10 according to the present embodiment. The server device 10 is an information processing apparatus (for example, a workstation, a personal computer, and the like) used when a system administrator and the like manage the game service. The server device 10 can distribute a game program operable on the player terminal 20, a web page made in a markup language (HTML, and the like), and the like according to a specification of the player terminal 20 upon receiving various commands (requests) from the player terminal 20. The server device 10 includes a control unit 11, a data storage unit 12, an input unit 13, a display unit 14, and a communication unit 15.

The control unit 11 performs data passing among units as well as controlling the whole server device 10, and is realized by a central processing unit (CPU) executing a program stored in a predetermined memory. The control unit 11 of the present embodiment includes a reservation registration unit 111 (registration unit), a providing unit 112, a determination unit 113, a recording unit 114, an update unit 115, a game value providing unit 116, a fusion processing unit 117, an initialization processing unit 118, and an image data generation unit 119.

The reservation registration unit 111 is connected to the data storage unit 12 through a bus, and includes a function to execute a process of registering data for reservation registration specified by the player in the data storage unit 12 in advance in response to an instruction from the control unit 11.

The providing unit 112 includes a function to execute a process of providing the player with the game contents to be used in a game described below. The game contents are game cards and figures, and the like associated with characters, and items such as tools and abilities that can be used in the game. The providing unit 112 in the present embodiment sequentially selects a group set with respect to a deck according to a selection order set in advance, and provides the player with a game content selected from the game contents that are selection candidates for each sequentially selected group.

The determination unit 113 includes a function to execute various determination processes such as a process of determining whether causing the player to possess the game content provided by the providing unit 112.

The recording unit 114 is connected to the data storage unit 12 through a bus, and includes a function to execute a process of recording data in the data storage unit 12 in response to an instruction from the control unit 11.

The update unit 115 is connected to the data storage unit 12 through a bus, and includes a function to execute a process of updating data stored in the data storage unit 12 in response to an instruction from the control unit 11.

The game value providing unit 116 includes a function to convert a game content to be sold into a game value corresponding to a value thereof, and to provide the converted game value to the player. The game value includes an exchange value that is exchanged with a service such as a game play of one time or a product (content) such as a game card/item, and examples of the game value include a virtual currency, a virtual medal, a play point.

The fusion processing unit 117 includes a function to execute a process of generating one game content by applying a fusion to a plurality of game contents.

The initialization processing unit 118 includes a function to execute a process of initializing deck information described below in response to a predetermined initialization condition having been met. The initialization condition includes, for example, the fact that an operation input to require initialization has been given from the player, the fact that a game content having highest rarity has been selected from a deck and provided to the player, the fact that the total held number of all game contents held in a deck becomes smaller than a given number, the fact that a predetermined time has elapsed, and the like. The initialization of the deck information means setting or updating deck information so that the held number of the game contents in a deck becomes equal to the total held number.

The image data generation unit 119 includes a function to execute a process of generating image data for displaying, in the player terminal 20, an operation screen that prompts the player to play a game, and a game screen. In the present embodiment, HTML data is generated as image data corresponding to a game image.

The data storage unit 12 includes a read only memory (ROM) that is a read only storage area in which a system program is stored, and a random access memory (RAM) that is a rewritable storage area used as a work area for an arithmetic process performed by the control unit 11. The data storage unit 12 is, for example, realized by a non-volatile storage device, such as a flash memory or a hard disk. The data storage unit 12 of the present embodiment at least stores card information that is information related to game cards as an example of the game content, player information that is information related to a player, and group information that is information related to groups configured from game cards that serve as selection candidates in decks described below. Note that each of the information will be described in detail.

The input unit 13 is used for inputting various data (for example, the card information and the like) by the system administrator, and the like, and is realized by, for example, a keyboard, a mouse, and the like.

The display unit 14 is used for displaying an operation screen for the system administrator based on a command from the control unit 11, and is, for example, realized by a liquid crystal display (LCD) and the like.

The communication unit 15 is used for performing communication with the player terminal 20, and has a function as a reception unit that receives various data and signals transmitted from the player terminal 20, and a function as a transmission unit that transmits various data and signals to the player terminal 20 according to a command of the control unit 11. The communication unit 15 is, for example, realized by a network interface card (NIC), and the like.

### <<Configuration of Player Terminal 20>>

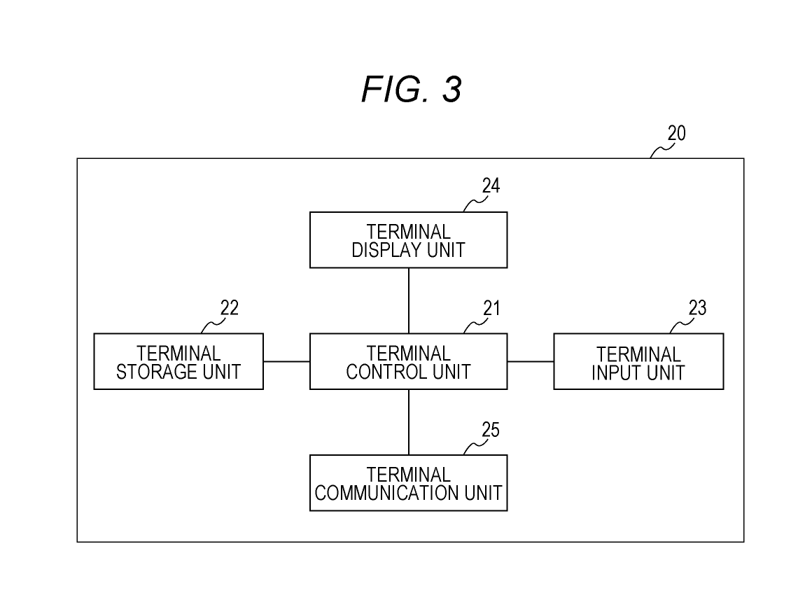

FIG. 3 is a block diagram illustrating a functional configuration of the player terminal 20. The player terminal 20 of the present embodiment is an information processing apparatus (for example, a mobile phone terminal, a smart phone, and the like) used by the player when a game is played, and can request distribution of various types of information (a game program, a web page, and the like) related to the game to the server device 10. Since the player terminal 20 has a web browser function for allowing the player to browse a web page, the web page (a game play image, and the like) distributed from the server device 10 can be displayed on a screen. The player terminal 20 includes a terminal control unit 21, a terminal storage unit 22, a terminal input unit 23, a terminal display unit 24, and a terminal communication unit 25.

The terminal control unit 21 performs data passing among units and controls the whole player terminal 20, and is realized by the central processing unit (CPU) executing a program stored in a predetermined memory. Note that the terminal control unit 21 of the present embodiment also functions as a screen display control unit for controlling a display form of a game screen displayed in the terminal display unit 24. The terminal storage unit 22 is connected to the terminal control unit 21 through a bus, and performs processing of referring to, reading out, rewriting stored data according to a command from the terminal control unit 21. The terminal storage unit 22 is realized, for example, by a flash memory, a hard disk, and the like. The terminal input unit 23 is used for performing various operations (a game operation, and the like) by the player, and is realized, for example, by an operation button, a touch panel, and the like. The terminal display unit 24 is used for displaying a game screen (a game image, an operation image, and the like) by a command from the terminal control unit 21, and is realized, for example, by a liquid crystal display (LCD) and the like. The terminal communication unit 25 functions as a transmission/reception unit for performing transmission/reception of various types of information with the server device 10 through the network 2, and is realized, for example, by a network interface card (NIC), and the like.

### <<Data Structure>>

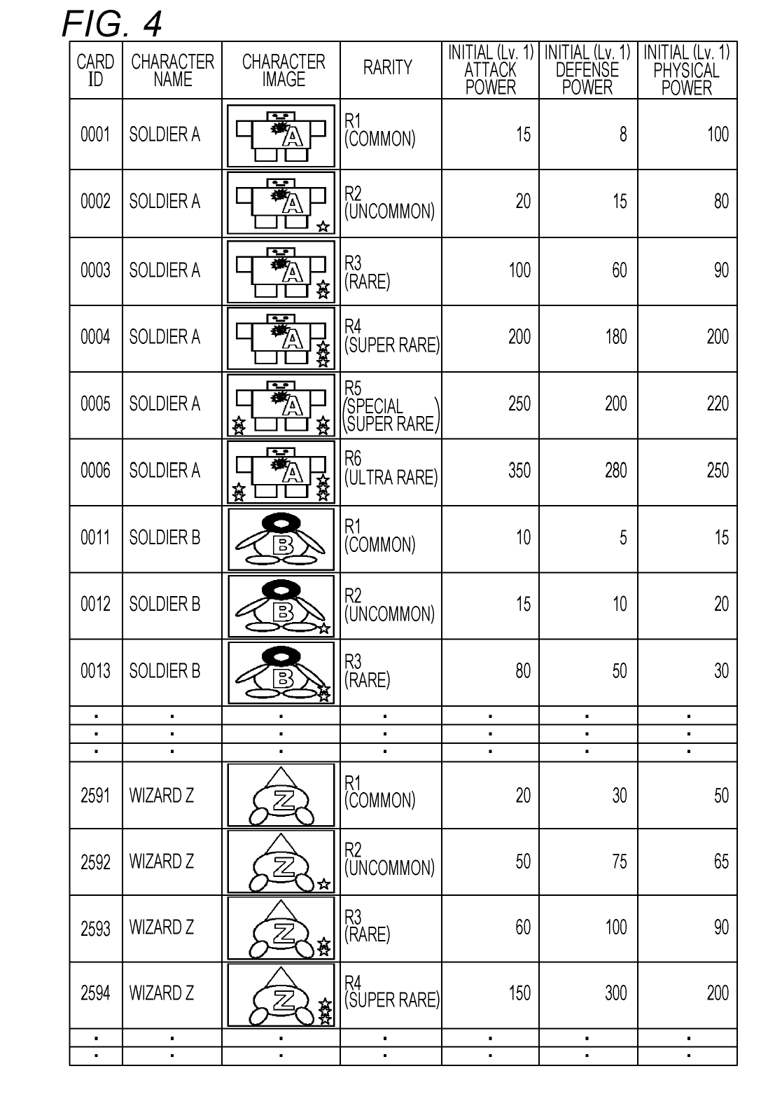

FIG. 4 is a diagram illustrating an example of a data structure of the card information stored in the data storage unit 12 of the server device 10. The card information includes items (fields) such as a card ID, a character name, a character image, rarity, initial attack power, initial defense power, and initial physical power. The card ID is identification information that identifies a game card as an example of the game content. The character name is information that indicates a display name of a character associated with a game card. The character image is image data of a character. The rarity is a parameter indicating the degree of rarity classified into a plurality of classes in accordance with a rarity value of a game card. In the present embodiment, six levels of classes (R1 “common”→R2 “uncommon”→R3 “rare”→R4 “super rare”→R5 “special super rare”→R6 “ultra rare”) are set to game cards (characters). The initial attack power, initial defense power, initial physical power, and the like of a character are parameters that indicate ability values initially set to the character.

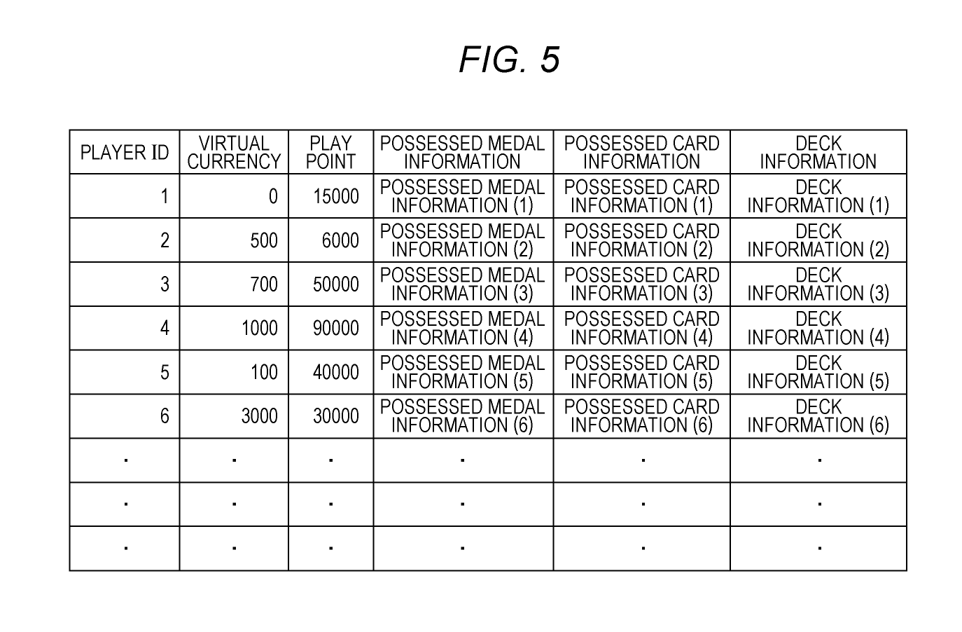

FIG. 5 is a diagram illustrating an example of a data structure of the player information stored in the data storage unit 12 of the server device 10. The player information includes items such as a player ID, a virtual currency, a play point, possessed medal information, possessed card information, deck information, and the like. The player ID is identification information that identifies the player. The virtual currency is an example of the game value, and is information indicating the amount of virtual currency possessed by the player. The player can purchase and possess the virtual currency. The play point is an example of the game value, and is information indicating the amount of play point possessed by the player. The player can acquire and possess the player point by selling a game card, or satisfying an acquisition condition such as winning of a battle game. The possessed medal information is information indicating a virtual medal as an example of the game value possessed by the player. The player can acquire and possess various virtual medals by satisfying an acquisition condition such as winning a battle game. The possessed card information is information that indicates a game card possessed by the player (hereinafter, also referred to as a possessed card). The deck information is information related to a deck in which a plurality of game cards is held. In this way, in the present embodiment, a deck is allocated to each player.

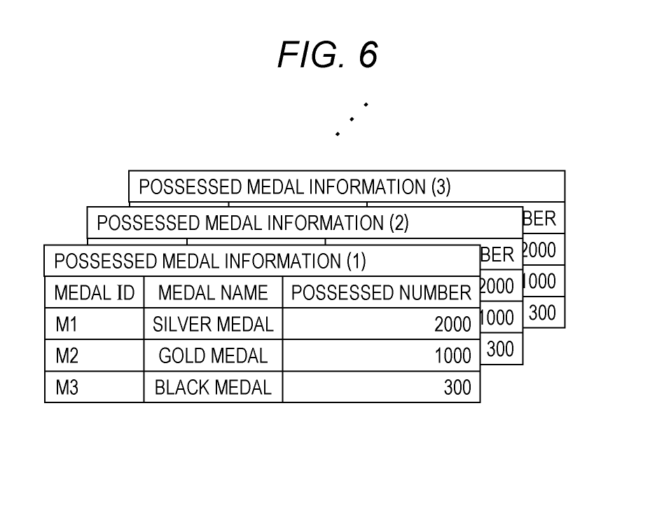

FIG. 6 is a diagram illustrating an example of a data structure of the possessed medal information. The possessed medal information includes items such as a medal ID, a medal name, the possessed number, and the like. The medal ID is information that identifies the various virtual medals owned by the player. The medal name is information that indicates a display name associated with a virtual medal. The possessed number is information indicating the amount of the virtual medals owned by the player. In the present embodiment, the player can own three types of virtual medals (a silver medal, a gold medal, and a black medal).

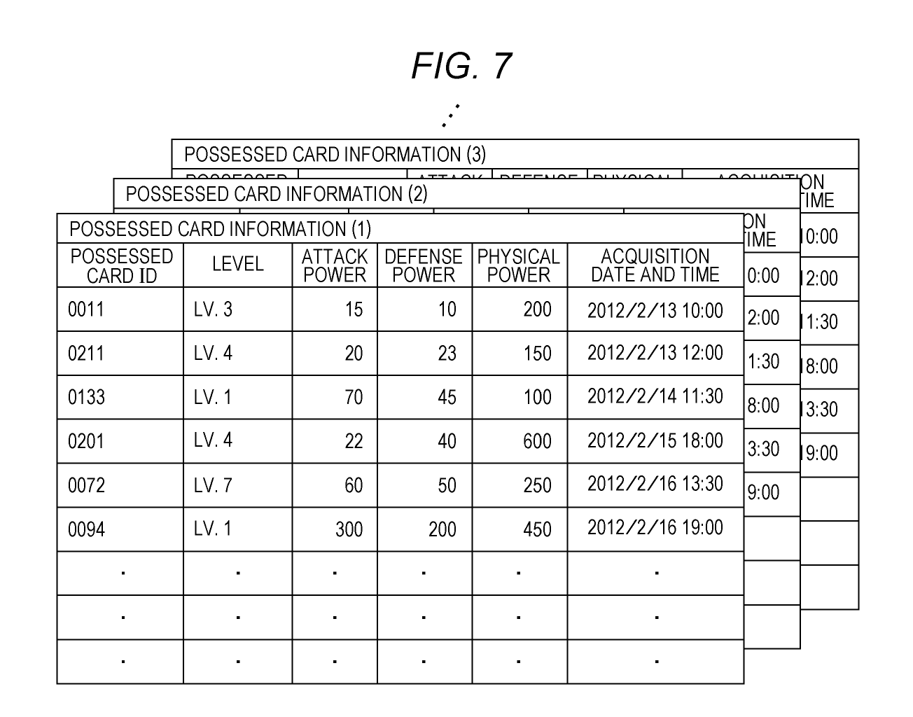

FIG. 7 is a diagram illustrating an example of a data structure of the possessed card information. The possessed card information includes items such as a possessed card ID, the level of a possessed card, attack power, defense power, an acquisition date and time, and the like. The possessed card ID is identification information that identifies a possessed card. The level of a possessed card, the attack power, and the defense power are parameters indicating ability values set to a character corresponding to a possessed card. These various parameters are updated in accordance with a result of a battle game and the like. The acquisition date and time is information indicating a date and time at which the player acquires a possessed card.

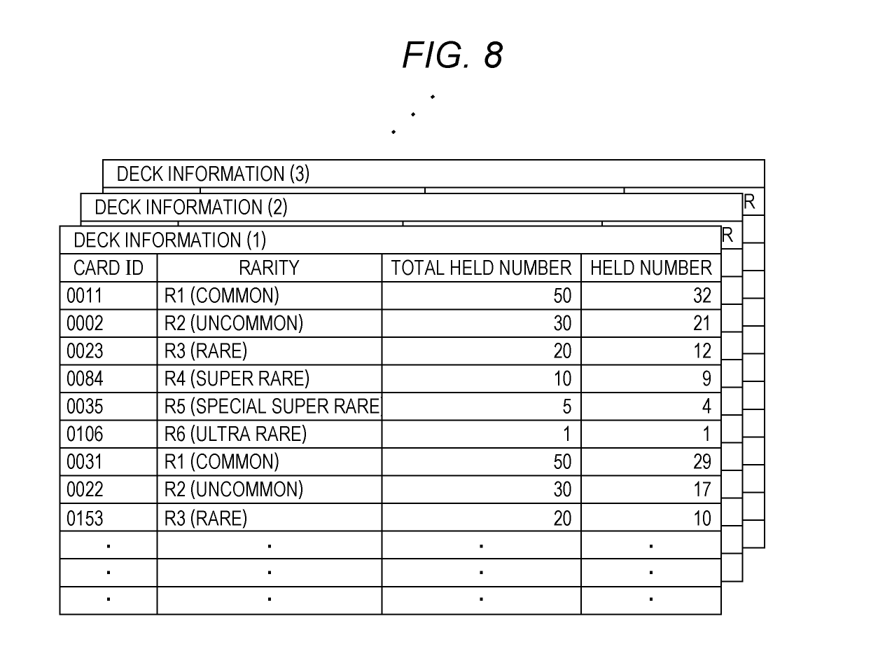

FIG. 8 is a diagram illustrating an example of a data structure of the deck information. The deck information is information that defines a game content held deck (also, simply referred to as “deck”) in which game cards that would be provided to the player are put together by each predetermined numbers. The deck information includes items of a card ID, rarity, the total held number, the held number, and the like.

The card ID is identification information that identifies each of the plurality of game cards held in the deck. The rarity is index information indicating the difficulty in acquiring a game content. In the present embodiment, the data structure is configured such that the lower the class of the rarity of a game card, the easier the card can be acquired, while the higher the class of the rarity of a game card, the more difficult the game card can be acquired. That is, as illustrated in FIG. 8, the deck information is set such that the higher the class of the rarity of a game card, the smaller the total number of the game card held in the deck. Therefore, a game card having a higher class of the rarity is less likely to be selected by randomly selecting a game card to be provided to the player from the game cards held in the deck.

The total held number is information indicating the number of game cards held in the deck in an initial state. In the present embodiment, as illustrated in FIG. 8, the total held number of game cards, in which the class of the rarity is set to the lowest class of the “R1 (common)”, is set to “50”. Meanwhile, the total held number of game cards, in which the class of the rarity is the highest class of the “R6 (ultra rare)”, is set to “1”. Therefore, in the initial state, the probability of selecting the game card of the “R6 (ultra rare)” is 1/50 of the probability of selecting the game card of the “R1 (common)” when a game card is randomly selected from the game cards held in the deck.

The held number is information indicating the number of game cards remained in the deck after game cards are provided to the player. That is, the held number is calculated by subtracting the number of the game cards provided to the player from the total held number of game cards. Therefore, the held number is calculated and updated/recorded everytime a game card is provided to the player.

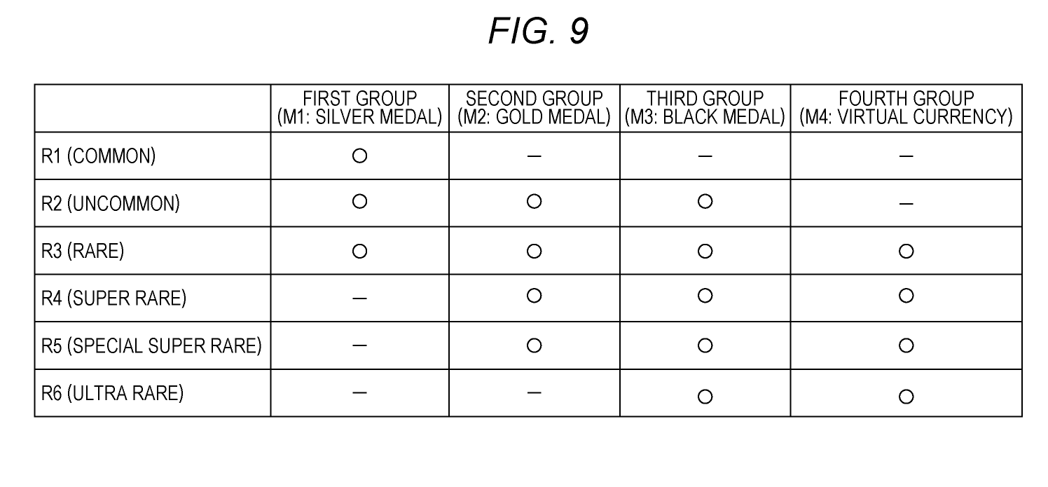

FIG. 9 is a diagram describing the group information stored in the data storage unit 12 of the server device 10. This group information is information for defining a group configured from game cards that serve as selection candidates from among the plurality of game cards held in the deck.

Here, the group information in the present embodiment will be described with reference to the table (see FIG. 9) in which each of the types of the game value (the silver medal, the gold medal, the black medal, and the virtual currency) and each class of the rarity (R1 to R6) are associated with each other. A plurality of types of groups corresponding to the types of the game values is set in the deck in the present embodiment, as illustrated in FIG. 9. To be specific, a first group corresponding to a silver medal (M1), a second group corresponding to a gold medal (M2), a third group corresponding to a black medal (M3), and a fourth group corresponding to a virtual currency (M4) are set. In a lottery game described below, when a silver medal is consumed for example, the first group from among the four groups is selected, and the game cards that constitute the first group becomes the selection candidates at the lottery.

The first group consists of the game cards to which the rarity of “R1 (common)” to “R3 (rare)” are set from among the plurality of game cards. The second group consists of the game cards to which the rarity of “R2 (uncommon)” to “R5 (special super rare)” are set. The third group consists of the game cards to which the rarity of “R2 (uncommon)” to “R6 (ultra rare)” are set. -The fourth group consists of the game cards to which the rarity of “R3 (rare) to R6 (ultra rare)” are set. In the lottery game described below, when the first group is selected, for example, any game cards from the game cards having the rarity of “R1 (common)”, “R2 (uncommon)”, and “R3 (rare)” are selected. In addition, when the second group is selected, for example, the game cards of “R4 (super rare)” and “R5 (special super rare)” become the selection candidates in addition to the selection candidates of the first group. Therefore, in the lottery game described below, the possibility in which a game card having higher rarity is selected is increased in order of the first group, the second group, the third group, and the fourth group. That is, the game value increases the value in order of the silver medal, the gold medal, the black medal, and the virtual currency. Therefore, in the present embodiment, the gold medal is less available than the silver medal, and the black medal is less available than the gold medal. Note that the virtual currency can be obtained by being purchased by the player with electronic money, which is different from various types of virtual medals. Therefore, the value of the virtual currency is higher than that of the virtual medals.

In addition, among the plurality of groups, it is configured such that a class of the rarity corresponding to any game card from among the game cards that serve as the selection candidates that constitute one group and a class of the rarity corresponding to any game card from among the game cards that serve as the selection candidates that constitute another group coincide with each other. That is, in the present embodiment, it is set such that a part of the classes of the rarity of each of the first to fourth groups overlaps with (coincides with) a class of another group. That is, the “R2 (uncommon)” overlaps in the second, the third, and the fourth group. The “R3 (rare)” overlaps in all of the first to fourth groups. The “R4 (super rare)” and the “R5 (special super rare)” overlap in the second to fourth groups. The “R6 (ultra rare)” overlaps in the third and fourth groups. In the lottery game described below, even if the first group is selected, or the second group is selected, for example, there is a possibility in which the game card of the “R3 (rare)” is selected.

### <<Outline of Game>>

Here, an outline of a game provided by the game system 1 of the present embodiment will be described. In the game system 1, a battle game performed using a game card (a virtual card used in a virtual space in the game) is provided.

### <Battle Game>

In the game system 1 of the present embodiment, the player can possess a plurality of game cards corresponding to game characters. The player can plays a battle game using a game card (character) selected from among a plurality of game cards owned by the player. The control unit 11 determines an enemy character that battles against a character selected by the player, and determines an outcome of the battle game between the characters based on the various parameters (the attack power, the defense power, the physical power, and the like) set to each character. In addition, in this battle game, the various virtual medals (the silver medal, the gold medal, and the black medal) and a play point are provided to the player in accordance with a battle result, and the like. The player can plays a lottery game described below using the virtual medal, and can perform card fusion described below using the play point.

### <Lottery Game>

In the game system 1 of the present embodiment, the player can play a lottery game, so-called “Gacha Gacha” (registered trademark) by consuming an own game value (the virtual medal or the virtual currency). In the present embodiment, an automatic gasha is performed as an example of the lottery game. The automatic gasha is a game in which a game card randomly selected from the limited number of game cards held in the deck is provided to the player. The deck holds the game cards to which the rarity classified into 6 classes (the R1 to R6, see FIG. 4) is set, and it is set such that the higher the class of the rarity, the smaller the held number of the game card (see FIG. 8). Therefore, a game card having a higher class of the rarity is less available.

The automatic gasha (lottery game) of the present embodiment limits the game cards that serve as the selection candidates from among the limited number of game cards held in the deck in accordance with the type of the game value to be consumed, and provides the player with a game card selected from among the limited selection candidates. That is, a plurality of groups configured from the game cards that serve as the selection candidates is set in the deck (the first to fourth groups, see FIG. 9), a group corresponding to the type of the game value to be consumed is selected from the plurality of groups, and a lottery of game card is performed in unit of the group. For example, when the lottery game is performed by the player consuming a virtual medal, for example, a group (the first to third groups, see FIG. 9) corresponding to the virtual medal (the silver medal, the cold medal, and the black medal) is selected from among the plurality of groups set in the deck. Meanwhile, when the lottery game is performed by the player consuming virtual currency, a group (the fourth group, see FIG. 9) corresponding to the virtual currency is selected. Then, the game cards that constitute the group selected in accordance with the type of the game value in this way becomes the selection candidates, a game card selected from among the game cards that serve as the selection candidates is provided to the player.

Further, in the automatic gasha (lottery game) of the present embodiment, the rarity value of the game card that would be provided to the player is varied depending on the rarity of the game cards that constitute the group set in the deck (that is, depending on the group to be selected). That is, the rarity of the game card that would be provided to the player is varied because a group to be selected is different when a lottery game is performed by the player consuming a virtual medal and when a lottery game is performed by the player consuming the virtual currency. Further, when a lottery game is performed by the player consuming a virtual medal, a group to be selected is different depending on the type of the virtual medal (the silver medal, the gold medal, and the black medal), and therefore, the rarity of a game card that would be provided to the player is varied. Therefore, the rarity of a game card that would be acquired by the player is influenced by how a game value to be consumed in performing a lottery game is selected, that is, which group is selected.

However, if there are many ways to perform a lottery game such that the lottery game is performed by consuming the virtual currency, or the lottery game is performed by consuming various virtual medals, the player needs to perform an operation input in accordance with each way. Further, it may be difficult for the player to understand the most efficient order to play the lottery game to acquire a game card having high rarity. Therefore, in the present embodiment, the groups set to the deck are automatically selected in sequence, and a game card selected from the game cards that serve as the selection candidates is provided to the player for each sequentially selected group. From this, a work required for the operation input can be reduced.

Note that the player can play a battle game described above using the game card provided by the lottery game. Further, the player can sell the game card provided in the lottery game, or can use the game card for card fusion.

### <Sale of Game Card>

In the game system 1 of the present embodiment, the player can possess only necessary cards without possessing an unwanted game card by selling the unwanted game card. When the unwanted game card is sold, the unwanted game card is converted into a game point corresponding to the value of the card, and the converted play point is provided to the player. In the present embodiment, there are a method of selling an unwanted game card by an operation of the player (manual sale), and a method of automatically selling an unwanted game card without an operation by the player (automatic sale). The player appropriately selects either the manual sale or the automatic sale depending on the situation.

In a case where the automatic sale is selected by the player, by reserving and registering the game card to be unwanted in advance, when the game card to be unwanted is provided by the lottery game, the game card can be automatically sold without an operation input by the player. From this, a work required for an operation input for selling an unwanted possessed card can be reduced.

### <Fusion of Game Card>

In the game system 1 of the present embodiment, the player can generate one game card by combining a plurality of game cards (applying fusion to the game cards to obtain one game card). By the fusion of the game cards, various parameters of a character corresponding to a game card after the fusion are varied (for example, the level, the attack power, the defense power, and the like).

In the present embodiment, the fusion of a game card is realized by consuming the player point possessed by the player and combining a base card with at least one material card. By the fusion of the game cards, the values of the parameters such as the level, the attack power, and the defense power set to the base card before the fusion are increased, and the increased new parameters are set to the base card after the fusion. When the fusion of the game cards is performed in this way, the player does not possess the both of the base card and the material card, and possesses only the base card after the fusion.

In the present embodiment, there are a method performing fusion of game cards by an operation of the player (manual fusion), and a method of automatically performing fusion of game cards without an operation by the player (automatic fusion). The player appropriately selects either the manual fusion or the automatic fusion depending on the situation.

In a case where the automatic fusion is selected by the player, by reserving and registering a game card that is to serve as a material card, when the game card that is to serve as a material card is provided by a lottery game, the material card can be automatically subjected to fusion with a case card without an operation input of the player. From this, a work required for an operation input for performing fusion of game cards can be reduced.

### <<Operation of Game System 1>>

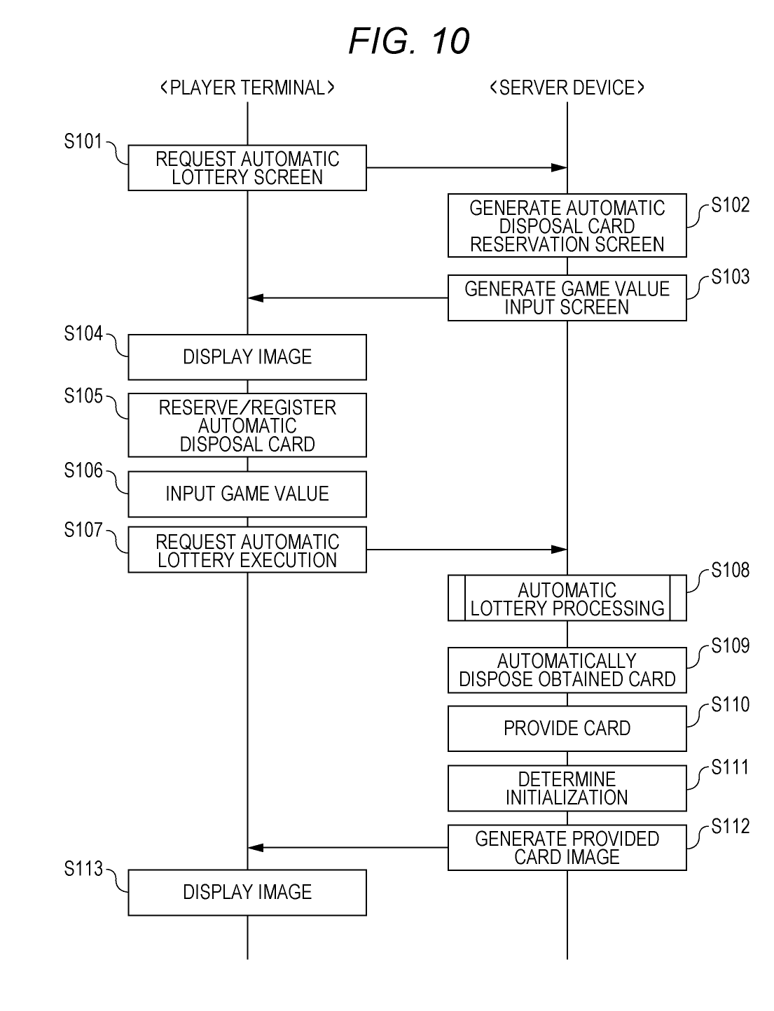

FIG. 10 is a flowchart for describing an operation example of a game system 1.

First, in the player terminal 20, the terminal control unit 21 transmits a command (automatic gasha start page request) for acquiring a web page to start an automatic gasha to the server device 10 through the terminal communication unit 25 upon receiving an operation input of the player from the terminal input unit 23 (S101).

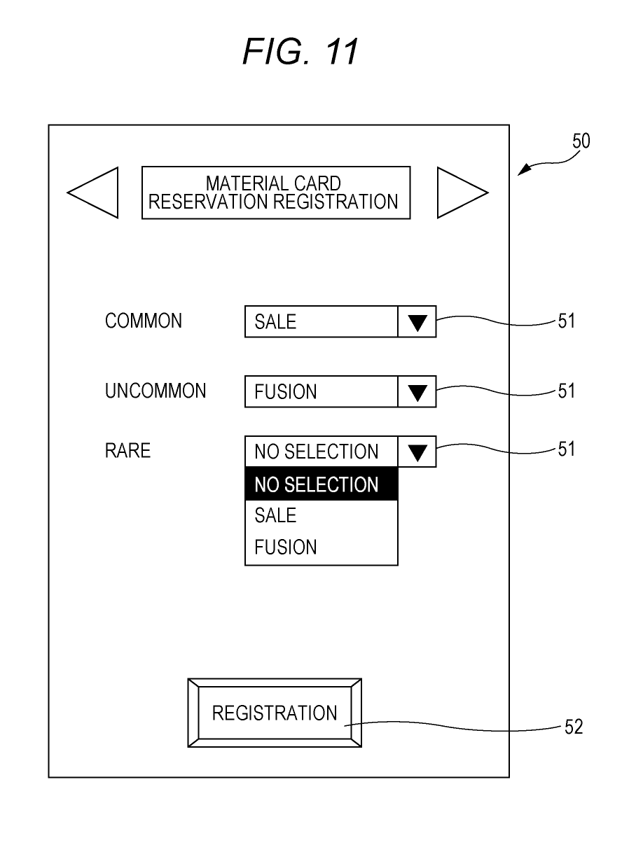

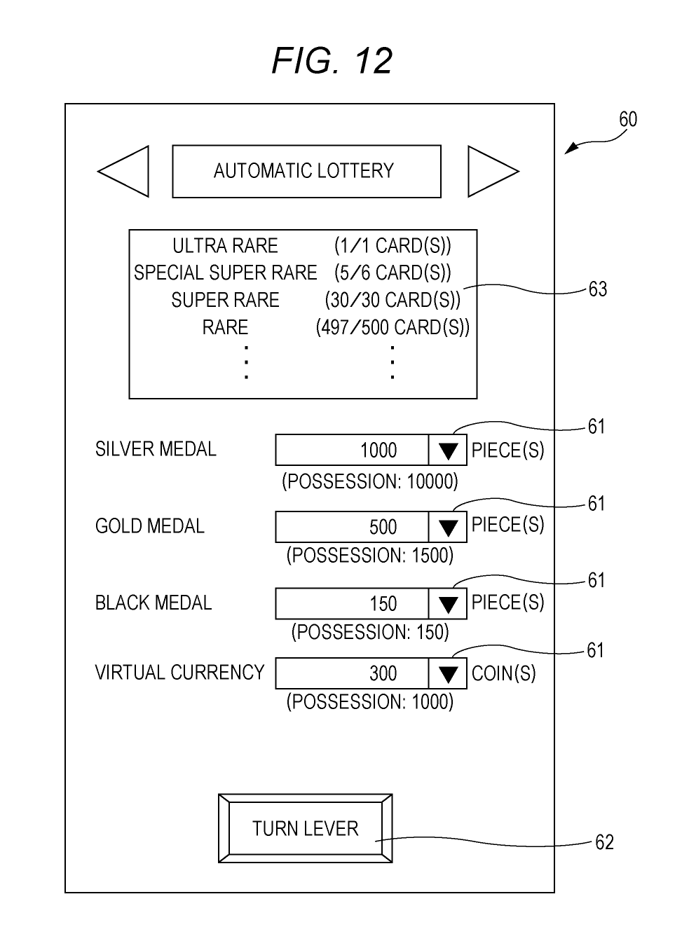

Next, the server device 10 causes the image data generation unit 119 to generate game image data (HTML data) for displaying the automatic disposal card registration screen (see FIG. 11) described below in the player terminal 20 (S102), and causes the image data generation unit 119 to generate game image data (HTML data) for displaying a game value input screen (see FIG. 12) described below in the player terminal 20 (S103), upon receiving the automatic gasha start page request transmitted from the player terminal 20. Then, the server device 10 transmits these game image data (HTML data) generated by the image data generation unit 119 to the player terminal 20 as a requestor through the communication unit 15.

Next, the player terminal 20 causes the terminal display unit 24 to display a game screen corresponding to the game image data by analyzing the game image data upon receiving the game image data (HTML data) transmitted from the server device 10 (S104).

FIG. 11 is a diagram illustrating an example of an automatic disposal card registration screen displayed in the terminal display unit 24. An automatic disposal card registration screen 50 is a game screen for allowing the player to designate the rarity to be automatically disposed, and to register the designated rarity in advance, and is configured from a pull-down menu 51 and a reservation registration button 52. The player terminal 20 receives an operation input related to the reservation registration from the player during the automatic disposal card registration screen 50 being displayed in the terminal display unit 24 (S105). The pull-down menu 51 includes three selection items: “no selection”, “sale”, and “fusion”. The player designates the rarity to be automatically disposed by operating the pull-down menu 51. Here, by the operation of the player, the rarity “common” is designated for the automatic disposal “sale”, the rarity “uncommon” is designated for the automatic disposal “fusion”, and the rarity “rare” is designated for the automatic disposal “no selection”. After the designation, when the reservation registration button 52 of material card is selected by the player, the player terminal 20 transmits a reservation registration request in which the operation information is set to the server device 10. When having received the request, the server device 10 performs reservation registration of each automatic disposal for each rarity designated by the player. That is, the reservation registration unit 111 registers a game card of “common” designated by the player in the data storage unit 12 in advance so that the game card becomes a card to be automatically disposed, registers a game card of “uncommon” designated by the player in the data storage unit 12 in advance so that the game card becomes a card to be used as a material card at the time of automatic fusion, and registers a game card of “rare” designated by the player in the data storage unit 12 in advance so that the game card becomes an object of “no selection”. Accordingly, when the rarity of the game card provided by an automatic gasha accords with “common”, the provided game card is automatically sold. Further, when the rarity of the game card provided by an automatic gasha accords with “uncommon”, the provided game card is used as a material card, and the material card and a base card are subjected to automatic fusion. Note that, when “no selection” is designated by the player, the game card provided by an automatic gasha is maintained as a possessed card of the player, and the possessed card information of the player (see FIG. 7) is updated.

FIG. 12 is a diagram illustrating an example of each game value input screen displayed in the terminal display unit 24. Each game value input screen 60 is a game screen for allowing the player to input the amount of game value to be consumed in performing an automatic gasha, and includes the pull-down menu 61, an operation button 62 for starting execution of a lottery process with an automatic gasha, and a deck held number information 63. The deck held number information 63 is information displaying the held number of the game cards in the deck in association with the total held number for each rarity. For example, the held number and the total held number are written together for each rarity like “ultra rare (1/1 card(s))” and “special super rare (5/6 card(s))”. With this display, the fact that one card from among all ultra rare game cards is remained and five out of six special super rare game cards are remained in the deck can be indicated to the player. That is, the player can see how many game cards among all game cards included in the deck have been selected (or decreased from the deck) by checking the information, and can determine the amount of the virtual medals to be input or the sum of virtual currency to be input. Note that, instead of displaying the held number in association with the total held number, even when the number of already selected cards is displayed in association with the total held number, it is apparent that similar effects can be obtained.

The player terminal 20 receives, from the player, an operation input related to the amount of each game value to be consumed in performing an automatic gasha during the game value input screen 60 being displayed in the terminal display unit 24 (S106). The player operates the pull-down menu 61 by reference to the held number indicated by the deck held number information 63, and designates the amount of game value to be consumed for each type of game value. Here, 1000 medals for the silver medal, 500 medals for the gold medal, 150 medals for the black medal, and 300 coins for the virtual currency are designated by the operation of the player. After the designation, when the operation button 62 is selected by the player, the player terminal 20 transmits an automatic gasha execution request in which the operation information is set to the server device 10 (S107).

Referring back to FIG. 10, the server device 10 executes an automatic gasha process in which a game card selected from the deck is provided to the player, upon receiving the automatic gasha execution request transmitted from the player terminal 20 (S108).

In this way, the player may just simply designate each amount of the various game values through the game value input screen 60, and it is not necessary to consider the most efficient order to play the lottery game using the game value to acquire a game card having high rarity, and not necessary to perform an operation input in accordance with each game value. Further, the server device 10 performs the automatic gasha process by receiving the designation of the various game cards together, automatically selects a group set in the deck in sequence, and provides, to the player, a game card selected from the game cards that serve as the selection candidates for each sequentially selected group.

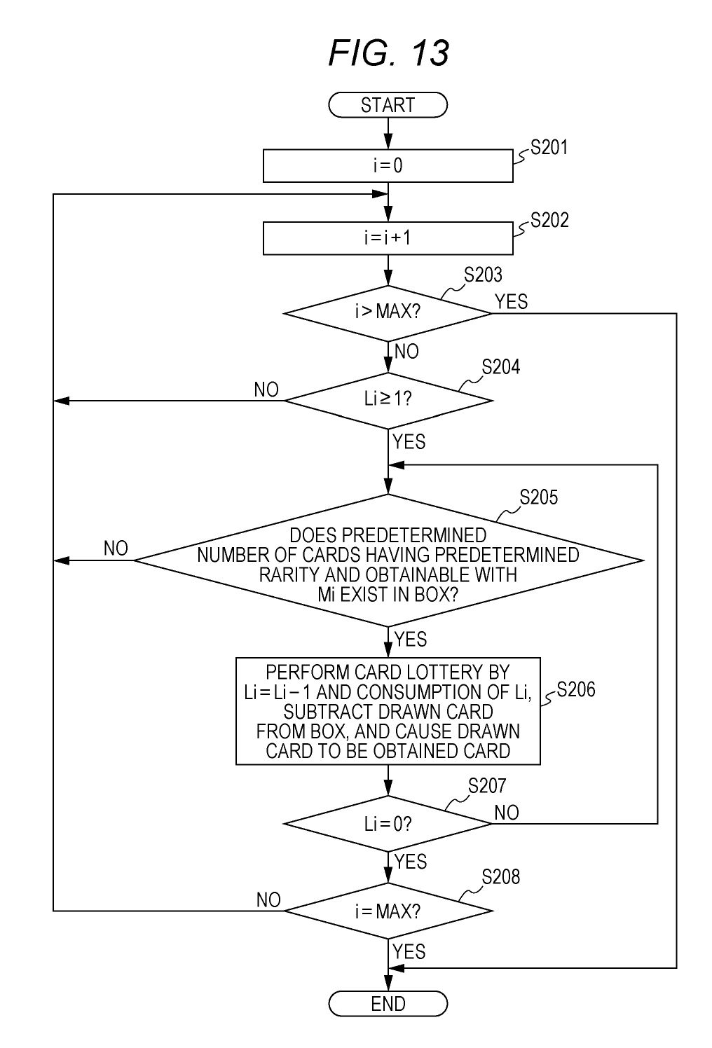

FIG. 13 is a flowchart for describing an automatic gasha process in the game system 1 according to the present embodiment.

First, an initial setting (i=0) of an index i is performed (S201). This index i corresponds to a type of game value (Mi). In the present embodiment, the index corresponds to the four game values: the silver medal, the gold medal, the black medal, and the virtual currency, and therefore, the maximum value (MAX) of the index i is set to 4. Further, a silver medal (M1) is set as a game value corresponding to the index i=1, a gold medal (M2) is set as a game value corresponding to the index i=2, a black medal (M3) is set as a game value corresponding to the index i=3, and a virtual currency (M4) is set as a game value corresponding to the index i=4. That is, as illustrated in FIG. 9, the providing unit 112 selects the first group (corresponding to the silver medal) first, which has a configuration that includes the game cards corresponding to the lowest class of rarity as the selection candidates and performs a lottery, and then, sequentially selects the second group (corresponding to the gold medal), the third group (corresponding to the black medal), and the fourth group (corresponding to the virtual currency) and performs lottery games. Accordingly, the game cards to which a lower degree of rarity is set can be decreased from the deck first. Therefore, the possibility in which a game card to which a higher degree of rarity is set is selected from the deck can be enhanced as the groups are sequentially selected.

Next, the index i is incremented by one (i=i+1) (S202), and whether the index i exceeds the maximum value (MAX=4) is determined (S203).

Then, when it is determined that the index i does not exceed the maximum value (MAX=4) (NO at S203), the process proceeds to step S204. Meanwhile, when it is determined that the index i exceeds the maximum value (MAX=4) (YES at S203), the automatic gasha process is terminated. That is, in the present embodiment, the maximum value (MAX) of the index i is 4. Therefore, the automatic gasha is started with a lottery game performed by consuming the silver medal (M1), and when lottery games are sequentially performed up to a lottery game performed by consuming the virtual currency (M4), the automatic gasha is over.

Next, in step S204, whether the number of lotteries (Li) of a lottery game performed by consuming the game value (Mi) is 1 or more is determined. In the present embodiment, regarding the virtual medal, one lottery game is performed by consuming one virtual medal. For example, when index i=1, one lottery game is performed by consuming one silver medal (M1). Therefore, when the silver medals designated by the player are 1000 medals, the number of lotteries (L1) with the silver medal (M1) is set to 1000 times (L1=1000). Then, whether L1 set in this manner is 1 or more is determined. Further, as for the virtual currency (when the index i=4), one lottery game is performed by consuming 100 coins of the virtual currency. Therefore, when the virtual currency designated by the player is 300 coins, the number of lotteries (L4) with the virtual currency (M4) is set to three times (L4=3). Then, whether L4 set in this manner is 1 or more is determined.

Then, when it is determined that the number of lotteries (Li) with the game value (Mi) is 1 or more (YES at S204), the process proceeds to step S205. Meanwhile, when it is determined that the number of lotteries (Li) with the game value (Mi) is not 1 or more (NO at S204), the process proceeds to step S202, the index i is incremented by one, and subsequent processes are repeated.

Next, in step S205, whether a predetermined number of game cards having predetermined rarity that would be granted in a lottery game performed by consuming a certain type of game value (Mi) exist in the deck is determined. For example, when an automatic gasha is performed by consuming the silver medal (M1) as the game value corresponding to the index i=1, the game cards that configure the first group among the game cards in the deck become the selection candidates (see FIG. 9). The rarity of the game cards that configure the first group is limited to the three classes: “R1 (common)”, “R2 (uncommon)”, and “R3 (rare)”, as illustrated in FIG. 9. Then, the held number of the game cards of “R3 (rare)” that is the highest class in the three classes is identified by reference to the deck information illustrated in FIG. 8. Whether the identified held number of the game cards of “R3 (rare)” is a predetermined number or more (for example, one or more) is determined.

As a result, when it is determined that a predetermined number of game cards having predetermined rarity exist in the deck (YES at S205), the process proceeds to step S206. Meanwhile, when it is determined that a predetermined number of game cards having predetermined rarity do not exist in the deck (NO at S205), the process returns to step S202, the index i is incremented by one, and subsequent processes are repeated. That is, describing the process using the above example, when an automatic gasha is performed by consuming the silver medal (M1) and the identified held number of the game cards of “R3 (rare)” is a predetermined number or more (for example, one or more) (at least one rare card (R3) exists in the deck), the providing unit 112 performs a lottery of a game card to be provided to the player using the game cards that configure the first group among the game cards in the deck as the selection candidate. Meanwhile, when the identified held number of the game cards of “R3 (rare)” is not a predetermined number or more (for example, one or more) (when the number of the rare cards (R3) in the deck becomes 0), the providing unit 112 performs a lottery by consuming the gold medal (M2) as the game value corresponding to the next index i=2 of the silver medal (M1). At this time, since the lottery with the silver medal (M1) is not performed, the silver medal (M1) that has not been consumed is returned to the player, and the update unit 115 updates the possessed medal information of the player (see FIG. 6). In this way, the providing unit 112 automatically selects the second group that is the next group of the current first group from among a plurality of groups set to the deck, and performs a lottery of a game card to be provided to the player using the game cards that configure the second group among the game cards in the deck as the selection candidate. Accordingly, selecting the next second group that has a possibility in which a game card having higher rarity than “R3 (rare)” is selected by consuming the gold medal is more advantageous for the player rather than performing a lottery game by selecting the first group that does not have the possibility in which a game card of “R3 (rare)” is selected by consuming the silver medal.

Next, in step S206, the number of lotteries (Li) with the game value (Mi) is decremented by one (Li=Li−1), and one time lottery with an automatic gasha (lottery game) is performed by consuming the game value (Mi) of one time. Then, based on a lottery result, the game card provided to the player by this lottery game is deleted from the deck. That is, when one or a plurality of game cards are provided by the providing unit 112 to the player, the update unit 115 decreases the held number by the number corresponding to the game cards provided to the player and updates the deck information (see FIG. 9). In addition, the update unit 115 updates the possessed card information (see FIG. 7) so that the game cards provided by the providing unit 112 to the player become game cards possessed by the player.

Note that, in step S206, when the game card provided by the providing unit 112 to the player is a game card of “R6 (ultra rare)” having the highest class of rarity, it may be controlled to stop next and subsequent lotteries by an automatic gasha. In the present embodiment, the total held number of the game cards of “R6 (ultra rare)” is set to one. Therefore, when the game card of “R6 (ultra rare)” is selected from the deck and is provided to the player, a game card of “R6 (ultra rare)” that is the highest class of rarity is no longer selected even if a lottery is repeated, and the game status turns against the player. Therefore, the fact that the game card of “R6 (ultra rare)” has been selected from the deck may be a stop condition of the lottery process.

At this time, the next and subsequent lotteries are not performed, the virtual medal or the virtual currency that have not been consumed are returned to the player, and the update unit 115 may update possessed medal information (see FIG. 6) and the player information (see FIG. 5) of the player.

Further, whether it is controlled to stop the next and subsequent lotteries with an automatic gasha by the fact that the stop condition of the lottery process is satisfied may be set by the player in advance. That is, when the reservation registration unit 111 has registered the control is effective according to an instruction input from the player, the providing unit 112 stops the next and subsequent lotteries with an automatic gasha based on the stop condition and controls the process not to provide a game card.

Note that a specific game card or rarity that satisfies the stop condition may be designated by the player in advance. Further, the number of cards may also be designated. For example, the player can designate the fact that a predetermined number of game cards of “R5 (special super rare)” has been selected as the stop condition.

Next, whether the number of lotteries (Li) with the game value (Mi) becomes zero (Li=0) is determined (S207). As a result of the determination, when it is determined that the number of lotteries (Li) with the game value (Mi) becomes zero (Li=0) (YES at S207), the process proceeds to step S208. Meanwhile, when it is determined that the number of lotteries (Li) with the game value (Mi) does not become zero (Li=0) (NO at S207), the process returns to step S205, and subsequent processes are repeated. That is, in the present embodiment, when the number of lotteries (L1) based on the amount of the silver medal designated by the player is set to 1000 times (L1=1000), the lotteries are repeatedly performed 1000 times until L1=0. Further, when the number of lotteries (L4) based on the sum of the virtual currency designated by the player is set to three times (L4=3), the lotteries are repeatedly performed three times until L4=0.

Next, in step S208, whether the index i coincides with the maximum value (MAX=4) is determined. When the index i coincides with the maximum value (YES at S208), the lottery game is performed and all types of game value have been consumed. Therefore, the automatic gasha (lottery game) is over. When the index i does not coincide with the maximum value (NO at S208), a type of game value (Mi) is still remained. Therefore, the process returns to step S202, the index i is incremented by one, and subsequent processes are repeated.

Referring back to FIG. 10, when the automatic gasha process ends, automatic disposal with respect to the game cards provided to the player as a result of the automatic gasha is performed (S109). To be specific, an automatic sale process or an automatic fusion process is performed with respect to the game cards provided by the providing unit 112 in the automatic gasha.

Here, the automatic sale process will be described. First, the determination unit 113 in the server device 10 determines whether the provided game card is made to be a game card to be possessed by the player by comparing the rarity of the game card provided by the providing unit 112 to the player, and the rarity designated by the player in the reservation registration.

Note that, when a plurality of game cards is provided by the providing unit 112 to the player at once, the determination unit 113 performs the comparison determination between the rarity of each card and the rarity designated in the reservation registration.

To be specific, the determination unit 113 determines whether the rarity of the provided game card and the rarity designated by the player accord with each other. When having determined that the rarities accord with each other, the determination unit 113 performs automatic sale of the provided game card. Meanwhile, when having determined that the rarities do not accord with each other, the determination unit 113 sets the provided game card to a possessed card. At this time, the recording unit 114 updates the possessed card information of the player (see FIG. 7) by adding and recording the provided game card in the data storage unit 12 as a possessed card of the player (S110).

To be specific, in the automatic sale, since the provided game card becomes an object to be automatically sold, the game value providing unit 116 of the server device 10 converts the provided game card into a play point and provides the point to the player. At this time, the recording unit 114 adds the provided point to the player information (see FIG. 5) and records and updates the player information.

Next, an automatic fusion process will be described. First, the determination unit 113 in the server device 10 determines whether the provided game card is made to be a game card to be possessed by the player by comparing the rarity of the game card provided by the providing unit 112 to the player and the rarity designated by the player in the reservation registration.

Note that, when a plurality of game cards is provided by the providing unit 112 to the player at once, the determination unit 113 performs the comparison determination between the rarity of each card and the rarity designate by the player in the reservation registration.

To be specific, the determination unit 113 determines whether the provided game card and the rarity designated by the player accord with each other. When having determined that the rarities accord with each other, the determination unit 113 determines whether the play points of the player are predetermined points or more by reference to the player information illustrated in FIG. 5. Meanwhile, when having determined that the rarities do not accord with each other, the determination unit 113 sets the provided game card to a possessed card of the player. At this time, the recording unit 114 updates the possessed card information of the player (see FIG. 7) by adding and recording the provided game card in the data storage unit 12 as the possessed card of the player (S110).

When the play points are the predetermined points or more, the determination unit 113 consumes the player points possessed by the player by the predetermined points (automatically updates the player information illustrated in FIG. 5), and performs fusion of the game cards by combining the provided game card with the base card, as the material card. Meanwhile, when the play points are short of the predetermined points, the determination unit 113 sets the provided game card to be a possessed card of the player. At this time, the recording unit 114 adds the provided game card to the possessed card information of the player (see FIG. 7), and records and updates the possessed card information.

To be specific, in the automatic fusion, the fusion processing unit 117 of the server device 10 reads out a base card registered in the data storage unit 12 in advance (base card designated by the player) in a case where the player himself has designated the base card, and combines the provided game card with the base card, as a material card. Further, the fusion processing unit 117 reads out a base card registered in the data storage unit 12 in advance (base card automatically designated without an operation by the player), and combines the provided game card with the base card, as a material card.

Note that, when a plurality of game cards is provided by the providing unit 112 to the player at once, the fusion processing unit 117 performs fusion of the game cards by combining the plurality of provided game cards with the base card, as the material cards.

When the material card is combined with the base card in this manner, the fusion processing unit 117 acquires the ability parameters such as the level of the base card, the attack power, and the defense power by reference to the possessed card information illustrated in FIG. 7, and changes the ability parameters to new ability parameters by increasing the values of the acquired ability parameters. The fusion processing unit 117 then sets the base card having the increased new ability parameters as the base card after fusion.

Next, when the game card is subjected to the fusion, the provided game card (material card) is not recorded in the data storage unit 12 as a possessed card of the player, but the base card after fusion is recorded in the data storage unit 12 as a possessed card of the player. That is, the recording unit 114 in the server device 10 records and updates the possessed card information illustrated in FIG. 5, and resets the base card after fusion to be a possessed card of the player (S110).

Next, in the server device 10, the determination unit 113 determines whether any of the initialization conditions have been satisfied (S111). When one of the initialization conditions has been satisfied, the initialization processing unit 118 initializes the deck. That is, the initialization processing unit 118 initializes the deck by updating the deck information (see FIG. 8) so that the held number of the game cards held in the deck becomes equal to the total held number.

Next, when the game card is provided to the player in this way, the server device 10 transmits the game image data (HTML data) generated by the image data generation unit 119 to the player terminal 20 as the requestor through the communication unit 15 (S112).

Next, the player terminal 20 displays a game screen corresponding to the game image data in the terminal display unit 24 by analyzing the game image data (HTML data) transmitted from the server device 10 (S113). On this game screen, information related to the lottery result of the automatic gasha is displayed. For example, display of a game card provided to the player, the held number of cards having various types of rarity in the deck after the lottery (the total held number may be written together), the amount of game value that has been consumed or not consumed by the lottery (the number of virtual medals and the sum of the virtual currency), the fact that a game card provided to the player has been automatically sold, the fact that a game card provided to the player has been automatically subjected to fusion with a base card as a material card, and the like are displayed. In this way, the player can confirm a lottery result and the like by seeing the game screen displayed in the terminal display unit 24.

As described above, according to the game system 1 of the present embodiment, when an operation input is received from the player regarding the amount of the various game values, the groups set to the deck are automatically selected in sequence according to the selection order set in advance, and a game card selected from among the game contents that serve as the selection candidates in each sequentially selected group is provided to the player by the providing unit 112. Therefore, it is not necessary for the player to consider the most efficient order to play the lottery game using the game value to acquire a game card having high rarity, and also not necessary to perform an operation input in accordance with each game value. Therefore, the work required for the operation input can be reduced.

### Other Embodiments

The above-described embodiments have been given for easy understanding of the present invention, and are not used to construe the present invention in a limited manner. The present invention can be changed and improved without departing from the gist of the invention and includes its equivalents. Especially, embodiments described below are also included in the present invention.

### <Group Information>

In the above-described embodiment, an example has been described, in which a plurality of types of groups corresponding to the types of game value (the silver medal (M1), the gold medal (M2), the black medal (M3), and the virtual currency (M4)) is set to the deck. However, the present invention is not limited to this example. For example, a plurality of types of groups corresponding to the amount of game value may be set to the deck. To be specific, a group corresponding to a case where the virtual currency is used in the first one lottery (100 coins) (the fifth group limited to the initial time (M5)), a group corresponding to a case where the virtual currency is used in three consecutive lotteries (900 coins) where the number of times is limited (the sixth group (M6) of three consecutive lotteries), a group corresponding to a case where the virtual currency is used in ten consecutive lotteries (3000 coins) where the number of times is limited) (the seventh group (M7) of ten consecutive lotteries), and a group corresponding to a case where the virtual currency is used in one lottery (the eighth group (M8) of one lottery), and the like may be set to the deck. In this case, the fifth group may be configured from the game cards to which the rarity of “R5 (special super rare)” is set among the plurality of game cards in the deck. When a lottery game is performed using the virtual currency for the first time (at the initial lottery), “R5 (special super rare)” can be surely provided. Further, the sixth group is configured from the game cards to which the rarity of “R3 (rare)” to “R6 (ultra rare)” is set, and one lottery out of three lotteries may be performed from the game cards of “R4 (super rare)” or more. Further, the seventh group is configured from the game cards to which the rarity of “R3 (rare)” to “R6 (ultra rare)” is set, and one lottery out of ten lotteries may be performed from the game cards of “R4 (super rare)” or more. Further, the eighth group may be configured from the game cards to which the rarity of “R3 (rare)” to “R6 (ultra rare)” is set.

<Lottery with Automatic Gasha>

In the above-described embodiment, an example has been described, as illustrated in FIG. 12, in which a lottery process with an automatic gasha is started in response to an operation input from the player (in response to the player pressing the operation button 62). However, the present invention is not limited to the example. For example, the lottery process with an automatic gasha may be automatically started based on the amount of game value registered by the player in advance.

To be specific, when the player designates and inputs the amounts of various game values first, the reservation registration unit 111 registers the input information in the data storage unit 12 in advance. For example, if the player designates such that the silver medal are 1000 medals, the gold medals are 200 medals, the black medals are 50 medals, the respective designated number of the various virtual medals are registered in advance.

Next, when the various virtual medals are provided by the providing unit 112 to the player as a result of a battle game, the update unit 115 updates the possessed medal information (see FIG. 6) based on the various virtual medals.

Next, the determination unit 113 identifies the number of the various virtual medals possessed by the player by referring to the possessed medal information (see FIG. 6), and compares the number of the various virtual medals registered in advance and the identified number. For example, the determination unit 113 determines whether the number of silver medals possessed by the player reaches 1000 silver medals registered by the player in advance.

Next, when the determination unit 113 has determined that the number of the various virtual medals possessed by the player has reached the number of the various virtual medals registered in advance, the number of the virtual medals registered in advance is automatically consumed, and the lottery process with an automatic gasha is automatically started. For example, when the determination unit 113 has determined that the number of the silver medals possessed by the player has reached 1000 silver medals registered by the player in advance, the providing unit 112 allows the 1000 silver medals to be automatically consumed, and provides the player with a game card selected from the deck by performing lotteries 1000 times.

Next, the game card provided by the automatic gasha becomes a possessed card of the player, and the possessed card information of the player (see FIG. 7) is updated.

In doing so, the work required for the operation input in performing an automatic gasha can be reduced.

### <Server Device>

In the above-described present embodiments, the game system 1 provided with one server device 10 as an example of a server device has been exemplarily described. However, the game system 1 is not limited to this example, and may be provided with a plurality of server devices 10 as an example of the server device. That is, a plurality of server devices 10 is connected through a network 2, and each of the server devices 10 may perform various types of processing in a distributed manner.

### <Information Processing Apparatus>

In the above-described game system 1 in the present embodiments, a case has been exemplarily described, in which various types of processing are executed based on a game program by the server device 10 and the player terminal 20 in cooperation with each other. However, the game system 1 is not limited to the example. The above-described various types of processing may be executed by the player terminal 20 alone or by the server device 10 alone as an information processing apparatus based on the game program.

Further, it may be configured such that the player terminal 20 bares a part of the functions as the information processing apparatus. In this case, the server device 10 and the player terminal 20 constitute the information processing apparatus.

What is claimed is:

1. A server device connected with a player terminal used by a player in a manner capable of information communication, comprising:
a storage unit configured to store deck information in which a plurality of game contents held in a deck is set, and group information in which a plurality of groups configured from game contents that serve as selection candidates among the plurality of game contents held in the deck;
a providing unit configured to sequentially select the groups according to a selection order set in advance based on the group information, and to provide the player with a game content selected from the game contents that serve as the selection candidates for each sequentially selected group, in response to a request from the player terminal; and
an update unit configured to update the deck information so that the game content provided by the providing unit becomes a game content not held in the deck,
wherein, in the deck information, the held number of game contents to be held in the deck is set corresponding to each game content, and
the providing unit selects a next group based on the held number of game contents that serve as selection candidates configuring a selected current group.

2. The server device according to claim 1,
wherein, in the deck information, the degree of rarity classified into a plurality of classes according to a rarity value is set corresponding to each game content, and
the providing unit first selects the group having a configuration including a game content corresponding to the degree of rarity of the lowest class.

3. A server device connected with a player terminal used by a player in a manner capable of information communication, comprising:
a storage unit configured to store deck information in which a plurality of game contents held in a deck is set, and group information in which a plurality of groups configured from game contents that serve as selection candidates among the plurality of game contents held in the deck;
a providing unit configured to sequentially select the groups according to a selection order set in advance based on the group information, and to provide the player with a game content selected from the game contents that serve as the selection candidates for each sequentially selected group, in response to a request from the player terminal; and
an update unit configured to update the deck information so that the game content provided by the providing unit becomes a game content not held in the deck,
wherein, in the deck information, the degree of rarity classified into a plurality of classes according to a rarity value is set corresponding to each game content, and
the providing unit first selects the group having a configuration including a game content corresponding to the degree of rarity of the lowest class.

4. The server device according to claim 1,
wherein, in the deck information, the degree of rarity classified into a plurality of classes according to a rarity value is set corresponding to each game content,
the group information is configured such that, among the plurality of groups, a class of the degree of rarity corresponding to any game content among game contents that serve as selection candidates and configure one group, and a class of the degree of rarity corresponding to any game content among game contents that serve as selection candidates and configure another group accord with each other, and
the providing unit,
between the one group and the another group, first selects a group including a game content corresponding to the degree of rarity of a lower class than the classes in accord in the game contents that serve as the selection candidates.

5. A server device connected with a player terminal used by a player in a manner capable of information communication, comprising:
a storage unit configured to store deck information in which a plurality of game contents held in a deck is set, and group information in which a plurality of groups configured from game contents that serve as selection candidates among the plurality of game contents held in the deck;
a providing unit configured to sequentially select the groups according to a selection order set in advance based on the group information, and to provide the player with a game content selected from the game contents that serve as the selection candidates for each sequentially selected group, in response to a request from the player terminal; and
an update unit configured to update the deck information so that the game content provided by the providing unit becomes a game content not held in the deck,
wherein, in the deck information, the degree of rarity classified into a plurality of classes according to a rarity value is set corresponding to each game content,
the group information is configured such that, among the plurality of groups, a class of the degree of rarity corresponding to any game content among game contents that serve as selection candidates and configure one group, and a class of the degree of rarity corresponding to any game content among game contents that serve as selection candidates and configure another group accord with each other, and
the providing unit,
between the one group and the another group, first selects a group including a game content corresponding to the degree of rarity of a lower class than the classes in accord in the game contents that serve as the selection candidates.

6. The server device according to claim 2, comprising:
a registration unit configured to register the degree of rarity designated by the player in advance;
a determination unit configured to determine whether the provided game content is made to be the game content possessed by the player by comparing the degree of rarity of the game content provided by the providing unit and the designated degree of rarity;
a fusion processing unit configured to apply fusion to the provided game content and another game content to generate a single game content after fusion, when it is determined that the provided game content is not made to be the game content possessed by the player; and
a recording unit configured no to record the provided game content as the game content possessed by the player, and to record the game content after fusion as the game content possessed by the player.

7. The server device according to claim 2, comprising:
a registration unit configured to register the degree of rarity designated by the player in advance;
a determination unit configured to determine whether the provided game content is made to be the game content possessed by the player by comparing the degree of rarity of the game content provided by the providing unit and the designated degree of rarity; and
a game value providing unit configured to convert the provided game content into a game value corresponding to a value of the game content, and to provide the player with the converted game value, when it is determined that the provided game content is not made to be the game content possessed by the player.

8. The server device according to claim 1,
wherein the storage unit stores player information in which a game value possessed by the player is set for each type, and
the providing unit
causes each type of the game value possessed by the player to be consumed, and provides the game content to be held in the deck, and
in providing the game content, sequentially selects any group from a plurality of groups based on each type of the consumed game value.

9. The server device according to claim 1,
wherein the storage unit stores player information in which an amount of a game value possessed by the player is set, and
the providing unit
causes the game value possessed by the player to be consumed, and provides the game content to be held in the deck, and
in providing the game content, selects any group from a plurality of groups based on the amount of the consumed game value.

10. The server device according to claim 1, comprising:
an initialization processing unit configured to initialize the deck information updated by the update unit according to an initialization condition having been satisfied.

11. A server device connected with a player terminal used by a player in a manner capable of information communication, comprising:
a storage unit configured to store deck information in which a plurality of game contents held in a deck is set, and group information in which a plurality of groups configured from game contents that serve as selection candidates among the plurality of game contents held in the deck;
a providing unit configured to sequentially select the groups according to a selection order set in advance based on the group information, and to provide the player with a game content selected from the game contents that serve as the selection candidates for each sequentially selected group, in response to a request from the player terminal;
an update unit configured to update the deck information so that the game content provided by the providing unit becomes a game content not held in the deck; and
an initialization processing unit configured to initialize the deck information updated by the update unit according to an initialization condition having been satisfied.

12. A non-transitory computer-readable storage medium storing game program for causing a computer as a server device connected with a player terminal used by a player in a manner capable of information communication to execute the processes of:
storing, in a storage unit, deck information in which a plurality of game contents held in a deck is set, and group information in which a plurality of groups configured from game contents that serve as selection candidates among the plurality of game contents held in the deck;
sequentially selecting the groups according to a selection order set in advance based on the group information, and providing the player with a game content selected from the game contents that serve as the selection candidates for each sequentially selected group, in response to a request from the player terminal; and
updating the deck information stored in the storage unit so that the provided game content becomes a game content not held in the deck,
wherein, in the deck information, the held number of game contents to be held in the deck is set corresponding to each game content, and
the computer is caused to execute, in the providing process, a process of selecting a next group based on the held number of game contents that serve as selection candidates configuring a selected current group.

13. A non-transitory computer-readable storage medium storing game program for causing a computer as a server device connected with a player terminal used by a player in a manner capable of information communication to execute the processes of:
storing, in a storage unit, deck information in which a plurality of game contents held in a deck is set, and group information in which a plurality of groups configured from game contents that serve as selection candidates among the plurality of game contents held in the deck;
sequentially selecting the groups according to a selection order set in advance based on the group information, and providing the player with a game content selected from the game contents that serve as the selection candidates for each sequentially selected group, in response to a request from the player terminal; and
updating the deck information stored in the storage unit so that the provided game content becomes a game content not held in the deck,
wherein, in the deck information, the degree of rarity classified into a plurality of classes according to a rarity value is set corresponding to each game content, and
the computer is caused to execute, in the providing process, a process of first selecting the group having a configuration including a game content corresponding to the degree of rarity of the lowest class.

14. A non-transitory computer-readable storage medium storing game program for causing a computer as a server device connected with a player terminal used by a player in a manner capable of information communication to execute the processes of:
storing, in a storage unit, deck information in which a plurality of game contents held in a deck is set, and group information in which a plurality of groups configured from game contents that serve as selection candidates among the plurality of game contents held in the deck;
sequentially selecting the groups according to a selection order set in advance based on the group information, and providing the player with a game content selected from the game contents that serve as the selection candidates for each sequentially selected group, in response to a request from the player terminal; and
updating the deck information stored in the storage unit so that the provided game content becomes a game content not held in the deck,
wherein, in the deck information, the degree of rarity classified into a plurality of classes according to a rarity value is set corresponding to each game content,
the group information is configured such that, among the plurality of groups, a class of the degree of rarity corresponding to any game content among game contents that serve as selection candidates and configure one group, and a class of the degree of rarity corresponding to any game content among game contents that serve as selection candidates and configure another group accord with each other, and
the computer is caused to execute, in the providing process,
between the one group and the another group, a process of first selecting a group including a game content corresponding to the degree of rarity of a lower class than the classes in accord in the game contents that serve as the selection candidates.

15. A non-transitory computer-readable storage medium storing game program for causing a computer as a server device connected with a player terminal used by a player in a manner capable of information communication to execute the processes of:
storing, in a storage unit, deck information in which a plurality of game contents held in a deck is set, and group information in which a plurality of groups configured from game contents that serve as selection candidates among the plurality of game contents held in the deck;
sequentially selecting the groups according to a selection order set in advance based on the group information, and providing the player with a game content selected from the game contents that serve as the selection candidates for each sequentially selected group, in response to a request from the player terminal; and
updating the deck information stored in the storage unit so that the provided game content becomes a game content not held in the deck,
initializing the deck information updated by the updating process according to an initialization condition having been satisfied.
